(19) United States
(12) Patent Application Publication
(10) Pub. No.: US 2024/0051843 A1
(43) Pub. Date: Feb. 15, 2024

(54) METHOD AND CRYSTALLIZATION DEVICE FOR PREPARING ELECTRONIC-GRADE NICKEL SULFATE FROM NICKEL POWDER, AND CONTROL METHOD OF THE CRYSTALLIZATION DEVICE

(71) Applicant: HUNAN JIN YUAN NEW MATERIALS JOINT STOCK COMPANY LIMITED, Yiyang (CN)

(72) Inventors: Xunbing LIU, Yiyang (CN); Can PENG, Yiyang (CN); Zhen LIU, Yiyang (CN); Quncheng ZHOU, Yiyang (CN); Zi WANG, Yiyang (CN); Xiongwu DONG, Yiyang (CN); Shanmu WU, Yiyang (CN); Jianjun OUYANG, Yiyang (CN)

(21) Appl. No.: 18/487,019

(22) Filed: Oct. 13, 2023

Related U.S. Application Data
(63) Continuation of application No. PCT/CN2022/088387, filed on Apr. 22, 2022.

(30) Foreign Application Priority Data
Jun. 23, 2021 (CN) 202110697258.1

(51) Int. Cl. C01G 53/10; B01D 9/00

(52) U.S. Cl. CPC C01G 53/10; B01D 9/0004; B01D 9/0063; B01D 2009/0086; C01P 2006/80

(57) ABSTRACT

The invention discloses a method and crystallization device for preparing electronic-grade nickel sulfate from nickel powder, and a control method of the crystallization device, and relates to the technical field of non-ferrous metal hydrometallurgy. The method comprises: oxidation, cooling, acid leaching, copper removal, acid adjustment, concentration, cooling crystallization, drying and screening, and secondary leaching: the oxidation comprises: controlling a temperature of nickel powder in a calcining furnace to be 400° C. to 700° C., allowing a use amount of compressed air for each kilogram of nickel powder to be 1 m³ to 5 m³, and making the reaction last for 1.0 hour to 2.5 hours; and the acid leaching comprises: placing cooled nickel oxide in a reactor, controlling a temperature to be 45° C. to 70° C., adding dilute sulfuric acid to control a pH value to be 0.5 to 1.5, and making the reaction last for 1 hour to 3 hours.

### TECHNICAL FIELD

The present invention relates to the technical field of non-ferrous metal hydrometallurgy, and particularly to a technology and equipment for preparing electronic-grade nickel sulfate from nickel powder, and a control method thereof.

### BACKGROUND OF THE PRESENT INVENTION

With the development of new energy electric vehicles, a power battery, as an important component, has also developed rapidly. With the change of the market, a battery consumption is increasing, and a positive electrode, as one of most important components of the battery, mainly has two series of lithium iron phosphate and Ni—Co—Mn ternary at present. With the continuous improvement of cruising range of electric vehicles, the Ni—Co—Mn ternary is developing in a direction of high nickel ratio. When the Ni—Co—Mn ternary is synthesized, nickel sulfate is the only raw material of nickel element. At present, a production capacity of nickel sulfate of a traditional production enterprise can no longer meet the production requirement of the Ni—Co—Mn ternary. Many enterprises have adopted the acid dissolution of metallic nickel to obtain the nickel sulfate after processing. However, a large amount of hydrogen is produced when the metallic nickel is subjected to the acid dissolution, which has extremely high requirements for equipment, environment and operation, and has certain safety risks. Meanwhile, in order to improve the production efficiency in the reaction process, a large amount of oxidizing agent needs to be added, which on one hand increases a production cost, and on the other hand easily brings in new impurities. Therefore, a method avoiding producing hydrogen in a production process of metallic nickel is needed to reduce the requirements for equipment, environment and operation, thus avoiding safety risks in the production process. Meanwhile, the addition of auxiliary materials in the process is reduced to avoid bringing in impurities.

### SUMMARY OF PRESENT INVENTION

### Technical Problem

The present invention aims to overcome the shortcomings and defects mentioned in the above background, and to disclose a method and crystallization device for preparing electronic-grade nickel sulfate from nickel powder, and a control method of the crystallization device, which can avoid producing hydrogen in a production process and avoid bringing in other impurity ions in the process.

### Solution of Problem

### Technical Solution

A first technical solution of the present invention is: a method for preparing and producing electronic-grade nickel sulfate from nickel powder, which comprises the following steps of: oxidation, cooling, acid leaching, copper removal, acid adjustment, concentration, cooling crystallization, drying and screening, and secondary leaching, wherein: the oxidation comprises: controlling a temperature of nickel powder in a calcining furnace to be 400° C. to 700° C., injecting 1 m³ to 5 m³ of compressed air for each kilogram of nickel powder, and making the reaction last for 1.0 hour to 2.5 hours, so that the nickel powder is oxidized in the furnace, and +2-valence nickel oxide is produced.

The cooling comprises: after the nickel powder is oxidized, cooling the oxidized nickel powder to normal temperature under protection of nitrogen or inert gas.

The acid leaching comprises: placing the cooled nickel oxide in a reactor, controlling a temperature to be 45° C. to 70° C., adding dilute sulfuric acid to control a pH value to be 0.5 to 1.5, and making the reaction last for 1 hour to 3 hours.

The copper removal comprises: filtering a nickel sulfate solution, then placing the filtered nickel sulfate solution in a reactor, controlling a reaction temperature to be 45° C. to 80° C., adding 0.8 to 2.0 times of nickel powder according to a mass ratio of a copper content, controlling a PH value to be 1.0 to 3.0, and making the reaction last for 0.5 hour to 2.5 hours.

The acid adjustment comprises: filtering the nickel sulfate solution subjected to the copper removal, placing the filtered nickel sulfate solution in a reactor, controlling a reaction temperature to be 55° C. to 90° C., and adjusting a PH value to be 2.5 to 4.5 with nickel carbonate or nickel hydroxide.

The concentration comprises: filtering the nickel sulfate solution subjected to the acid adjustment, and evaporating and concentrating a filtrate.

The cooling crystallization comprises: making the nickel sulfate solution subjected to the concentration flow into a crystallization device to be cooled, separating nickel sulfate from the solution to form crystals, and after the crystals are separated, returning a mother solution to the concentration.

The drying and screening comprise: drying the separated nickel sulfate crystals by a vibrated fluidized bed to remove free water, and then making the dried crystals enter a vibrating screen for screening, wherein an oversize material is a nickel sulfate product, and undersize material particles are fine and returned to the crystallization to be used as seed crystals.

The secondary leaching comprises: placing a leaching slag containing a certain amount of nickel in a reactor, adding dilute sulfuric acid to control a PH value to be 0.5 to 1.5, controlling a reaction temperature to be 45° C. to 70° C., taking nickel sulfide or hydrogen peroxide as a reducing agent, with a use amount of 15% to 35% of a nickel content in the acid leaching slag, making the reaction last for 1 hour to 3 hours, taking the slag for nickel detection, when the nickel is less than 0.1%, regarding the slag as a waste slag, when the nickel is greater than 0.1%, continuously returning the slag to the secondary leaching, and returning a leachate to the acid leaching to be used as bottom water or merge with a first leachate to enter the next procedure, so as to ensure a recovery rate of nickel.

Further, the oxidation comprises: controlling the temperature of nickel powder in the calcining furnace to be 450° C. to 600° C., preferably 500° C., injecting 3 m³ to 4 m³ of compressed air for each kilogram of nickel powder, and making the reaction last for 1.0 hour to 1.5 hours.

Further, the acid leaching comprises: placing the cooled nickel oxide in the reactor, controlling the temperature to be 50° C. to 60° C., adding the dilute sulfuric acid to control the pH value to be 1, and making the reaction last for 2 hours.

Further, the copper removal comprises: filtering the nickel sulfate solution, then placing the filtered nickel sulfate solution in the reactor, controlling the reaction temperature to be 45° C. to 70° C., preferably 55° C. to 70° C., adding 1.3 to 1.5 times of nickel powder according to the mass ratio of the copper content, controlling the PH value to be 2.0 to 2.5, and making the reaction last for 1 hour to 2 hours.

Further, the acid adjustment comprises: filtering the nickel sulfate solution subjected to the copper removal, placing the filtered nickel sulfate solution in the reactor, controlling the reaction temperature to be 60° C. to 80° C., and adjusting the PH value to be 3.0 to 4.0 with the nickel carbonate or the nickel hydroxide.

Further, the acid adjustment comprises: filtering the nickel sulfate solution subjected to the copper removal, placing the filtered nickel sulfate solution in the reactor, controlling the reaction temperature to be 70° C. to 75° C., and adjusting the PH value to be 3.5 with the nickel carbonate or the nickel hydroxide.

Further, the secondary leaching comprises: placing the leaching slag containing the certain amount of nickel in the reactor, adding the dilute sulfuric acid to control the PH value to be 1.0, controlling the reaction temperature to be 50° C. to 65° C., taking the nickel sulfide as the reducing agent, with the use amount of 20% to 30% of the nickel content in the acid leaching slag, and making the reaction last for 2 hours.

A second technical solution of the present invention is: a crystallization device for preparing electronic-grade nickel sulfate from nickel powder, wherein the crystallization device is composed of a first-stage crystallizer, a second-stage crystallizer and a third-stage crystallizer which are connected in series, the crystallizer is composed of a crystallization frame, an oscillator arranged below the crystallization frame and a liquid discharge port with a control valve arranged at a liquid outlet end of the crystallization frame, the crystallization frame is made into a cuboid, raised strips with an arc-shaped cross section are uniformly distributed at a bottom portion of the crystallization frame, a distance S between two adjacent raised strips is 1/25 to 1/15 of a width of the crystallization frame 4, and a width b and a height h of the raised strip are both 1/100 to 1/150 of the width of the crystallization frame.

Further, the distance S between two adjacent raised strips is 1/20 of the width of the crystallization frame, and the width b and the height h of the raised strip are both 1/110 to 1/130, preferably 1/120, of the width of the crystallization frame.

A third technical solution of the present invention is: a control method of a crystallization device for preparing electronic-grade nickel sulfate from nickel powder, which comprises the following steps of:
a: starting a first-stage crystallizer: making a concentrated nickel sulfate solution flow into the first-stage crystallizer, turning on an oscillator, with a frequency of the oscillator not allowing a cobalt sulfate solution to overflow a crystallization frame, after a temperature of the nickel sulfate solution reaches 45° C., making the nickel sulfate solution flow into a second-stage crystallizer through a liquid discharge port with a control valve, and collecting and then merging crystals in the crystallization frame to enter the next procedure;
b: starting the second-stage crystallizer: after the nickel sulfate solution is placed in the second-stage crystallizer, adding undersize material fine particles of the nickel sulfate crystals in the screening procedure for crystallization, other operations being the same as the operations of the first-stage crystallizer 1, after the temperature of the nickel sulfate solution reaches 35° C., making the nickel sulfate solution flow into a third-stage crystallizer through a liquid discharge port with a control valve of the second-stage crystallizer, and collecting and then merging crystals in the crystallization frame of the second-stage crystallizer to enter the next procedure; and
c: starting the third-stage crystallizer: after the nickel sulfate solution is placed in the third-stage crystallizer, adding undersize material fine particles of the nickel sulfate crystals in the screening procedure for crystallization, other operations being the same as the operations of the first-stage crystallizer, after the temperature of the nickel sulfate solution reaches room temperature, making the nickel sulfate solution flow into a liquid storage tank through a liquid discharge port with a control valve of the third-stage crystallizer, and collecting and then merging crystals in the crystallization frame of the third-stage crystallizer to enter the next procedure.

### Beneficial Effects of Invention

### Beneficial Effects

Due to the adoption of the above technical solutions, the present invention has the following advantages: (1) due to the adoption of the above oxidation preprocessing, an addition amount of oxygen and a certain temperature are controlled, the metallic nickel is oxidized into the bivalent nickel oxide, the hydrogen will not be released when the acid is added for dissolution, and it is unnecessary to add a large amount of oxidizing agent.

(2) Due to the adoption of the copper removal of replacing copper with the nickel powder, no new impurity ions are added in the process, and a concentration of nickel ions is relatively increased.

(3) Due to the adoption of the acid adjustment with the nickel hydroxide or the nickel carbonate, impurities are not increased, an acidity of the solution is reduced, and free acid of the nickel sulfate crystals is controlled.

(4) Due to the adoption of the crystallization device, the crystallization process is dynamic, and due to the unique structure, the nickel sulfate will not produce caking or large irregular particles during crystallization.

(5) Due to the adoption of the screening, the fine undersize particles after the screening are returned to the crystallizer to be used as the seed crystals, so that the nickel sulfate crystal particles are more uniform.

(6) Due to the adoption of the unique control method, the crystallization device has the following advantages: a. the crystallization process is carried out under a controllable dynamic condition, and a granularity of crystallization is controllable;
b. the situations of super-large particles, irregular particles and crystal hardening produced under a static condition are avoided;
c. three-stage cooling is adopted in the process, which avoids an influence of an increasing thickness of a crystallization layer during the cooling crystallization on heat dissipation; and
d. the fine undersized nickel sulfate crystals are added into the second and third stage crystallization frames, which act as the seed crystals, thus ensuring the proportion of the oversize material of the nickel sulfate.

### DESCRIPTION OF THE DRAWINGS

### Brief Description of the Drawings

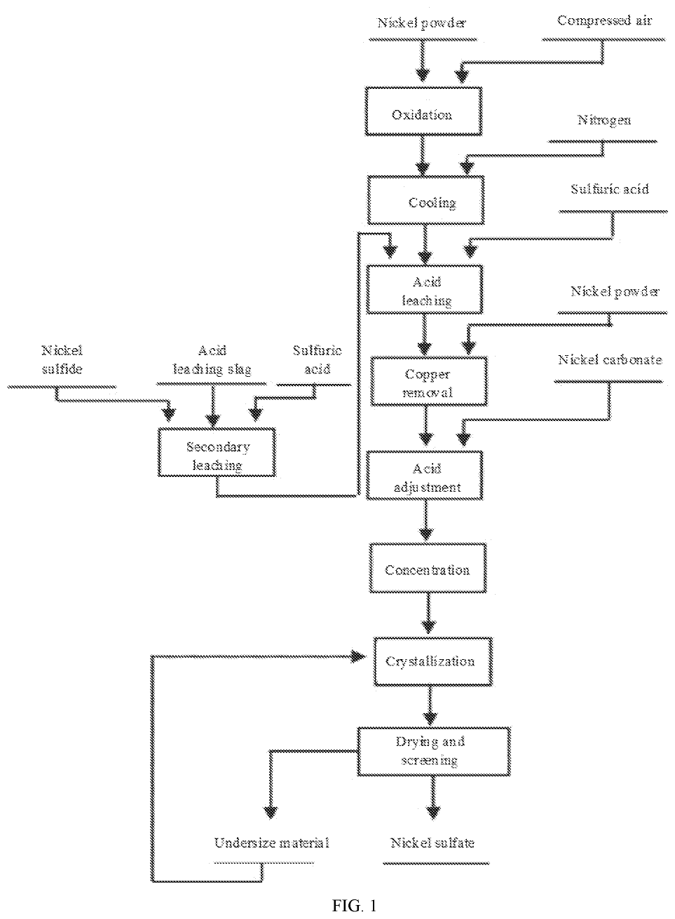

FIG. 1 is a process flow chart of the present invention.

FIG. 2 is a schematic diagram of a front-view structure of an embodiment of a crystallization device according to the present invention.

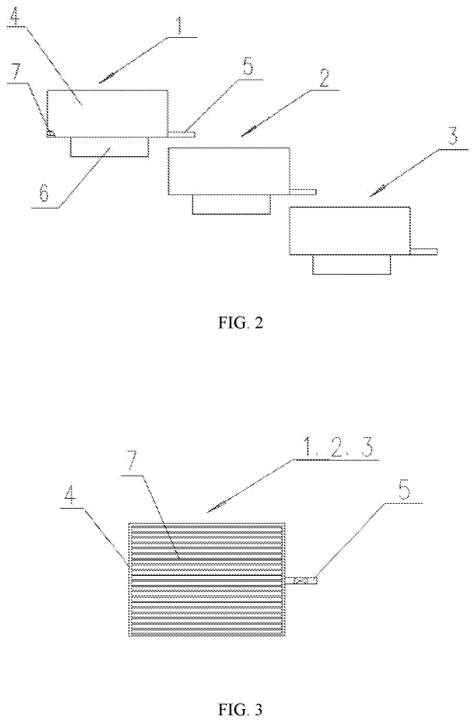

FIG. 3 is a schematic diagram of a top-view structure of the embodiment of the crystallization device according to the present invention.

FIG. 4 is a schematic diagram of a side-view sectional structure of a crystallization frame of the embodiment of the crystallization device according to the present invention.

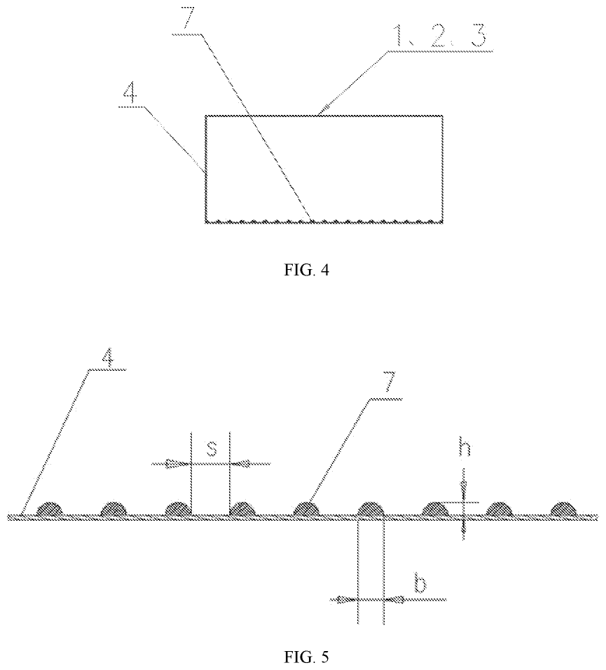

FIG. 5 is an enlarged diagram of the side-view sectional structure of the crystallization frame of the embodiment of the crystallization device according to the present invention.

Reference numerals: 1 refers to first-stage crystallizer, 2 refers to second-stage crystallizer, 3 refers to third-stage crystallizer, 4 refers to crystallization frame, 5 refers to liquid discharge port, 6 refers to oscillator, and 7 refers to raised strip.

### OPTIMAL EMBODIMENTS FOR IMPLEMENTING THE PRESENT INVENTION

### Optimal Implementations of the Present Invention

A method for preparing and producing electronic-grade nickel sulfate from nickel powder comprises the following steps of: oxidation, cooling, acid leaching, copper removal, acid adjustment, concentration, cooling crystallization, drying and screening, and secondary leaching.

Preferably, the oxidation comprises: controlling a temperature of nickel powder in a calcining furnace to be 650° C., injecting 3 m³ of compressed air for each kilogram of nickel powder, and making the reaction last for 1.5 hours, so that the nickel powder is oxidized in the furnace, and +2-valence nickel oxide is produced.

Preferably, the cooling comprises: after the nickel powder is oxidized, cooling the oxidized nickel powder to normal temperature under protection of nitrogen or inert gas.

Preferably, the acid leaching comprises: placing the cooled nickel oxide in the reactor, controlling the temperature to be 55° C., adding the dilute sulfuric acid to control the pH value to be 1.0, and making the reaction last for 2 hours.

Preferably, the copper removal comprises: filtering a nickel sulfate solution, then placing the filtered nickel sulfate solution in a reactor, controlling a reaction temperature to be 75° C., adding to 0.95 times of nickel powder according to a mass ratio of a copper content, controlling a PH value to be to 2.0, and making the reaction last for hour to 1 hour.

Preferably, the acid adjustment comprises: filtering the nickel sulfate solution subjected to the copper removal, placing the filtered nickel sulfate solution in a reactor, controlling a reaction temperature to be 75° C., and adjusting a PH value to be to 3.0 with nickel carbonate or nickel hydroxide.

Preferably, the concentration comprises: filtering the nickel sulfate solution subjected to the acid adjustment, and concentrating a filtrate.

Preferably, the cooling crystallization comprises: making the nickel sulfate solution subjected to the concentration flow into a crystallization device to be cooled, separating nickel sulfate from the solution to form crystals in a temperature reduction process, and after the crystals are separated, returning a mother solution to the concentration.

Preferably, the drying and screening comprise: drying the separated nickel sulfate crystals by a vibrated fluidized bed to remove free water, and then making the dried crystals enter a vibrating screen for screening, wherein an oversize material is a nickel sulfate product, and undersize material particles are fine and returned to the crystallization to be used as seed crystals.

Preferably, the secondary leaching comprises: placing a leaching slag containing a certain amount of nickel in a reactor, adding dilute sulfuric acid to control a PH value to be to 1.0, controlling a reaction temperature to be 65° C., taking nickel sulfide or hydrogen peroxide as a reducing agent, with a use amount of to 25% of a nickel content in the acid leaching slag, making the reaction last for hour to 2 hours, taking the slag for nickel detection, when the nickel is less than 0.1%, regarding the slag as a waste slag, when the nickel is greater than 0.1%, continuously returning the slag to the secondary leaching, and returning a leachate to the acid leaching to be used as bottom water or merge with a first leachate to enter the next procedure, so as to ensure a recovery rate of nickel.

A crystallization device for preparing electronic-grade nickel sulfate from nickel powder is provided, wherein the crystallization device is composed of three crystallizers with the same structure connected in series, which means that the crystallization device is composed of a first-stage crystallizer 1, a second-stage crystallizer 2 and a third-stage crystallizer 3 which are connected in series, the crystallizer is composed of a crystallization frame 4, an oscillator 6 arranged below the crystallization frame 4 and a liquid discharge port 5 with a control valve arranged at a liquid outlet end of the crystallization frame 4, the crystallization frame 4 is made into a cuboid, raised strips 7 with an arc-shaped cross section are uniformly distributed at a bottom portion of the crystallization frame 4, a distance S between two adjacent raised strips 7 is 1/20 of a width of the crystallization frame 4, and a width b and a height h of the raised strip 7 are both 1/120 of the width of the crystallization frame 4.

A control method of a crystallization device for preparing electronic-grade nickel sulfate from nickel powder comprises the following steps of: a: starting a first-stage crystallizer: making a concentrated nickel sulfate solution flow into the first-stage crystallizer, turning on an oscillator, with a frequency of the oscillator not allowing a cobalt sulfate solution to overflow a crystallization frame, after a temperature of the nickel sulfate solution reaches 45° C., making the nickel sulfate solution flow into a second-stage crystallizer through a liquid discharge port with a control valve, and collecting and then merging crystals in the crystallization frame to enter the next procedure;
b: starting the second-stage crystallizer: after the nickel sulfate solution is placed in the second-stage crystallizer, adding undersize material fine particles of the nickel sulfate crystals in the screening procedure for crystallization, other operations being the same as the operations of the first-stage crystallizer 1, after the temperature of the nickel sulfate solution reaches 35° C., making the nickel sulfate solution flow into a third-stage crystallizer through a liquid discharge port with a control valve of the second-stage crystallizer, and collecting and then merging crystals in the crystallization frame of the second-stage crystallizer to enter the next procedure; and
c: starting the third-stage crystallizer: after the nickel sulfate solution is placed in the third-stage crystallizer, adding undersize material fine particles of the nickel sulfate crystals in the screening procedure for crystallization, other operations being the same as the operations of the first-stage crystallizer, after the temperature of the nickel sulfate solution reaches room temperature, making the nickel sulfate solution flow into a liquid storage tank through a liquid discharge port with a control valve of the third-stage crystallizer, and collecting and then merging crystals in the crystallization frame of the third-stage crystallizer to enter the next procedure.

### DETAILED DESCRIPTION OF PREFERRED EMBODIMENTS

### Implementations of the Present Invention

In order to understand the present invention more clearly, the present invention is further described hereinafter by specific embodiments with reference to FIG. 1 to FIG. 5.

Implementation Mode 1: as shown in FIG. 1, a method for preparing and producing electronic-grade nickel sulfate from nickel powder comprises the following steps of: oxidation, cooling, acid leaching, copper removal, acid adjustment, concentration, cooling crystallization, drying and screening, and secondary leaching, wherein: the oxidation comprises: controlling a temperature of nickel powder in a calcining furnace to be 400° C. to 700° C., injecting 1 m³ to 5 m³ of compressed air for each kilogram of nickel powder, and making the reaction last for 1.0 hour to 2.5 hours.

Further, the oxidation comprises: controlling the temperature of nickel powder in the calcining furnace to be 450° C. to 600° C., preferably 500° C., injecting 3 m³ to 4 m³ of compressed air for each kilogram of nickel powder, and making the reaction last for 1.0 hour to 1.5 hours.

In some embodiments, the temperature of nickel powder in the calcining furnace is controlled to be 400° C., 450° C., 500° C. and 550° C.

In some embodiments, 1 m³, 2 m³, 3 m³, 4 m³ and 5 m³ of compressed air are injected for each kilogram of nickel powder.

The nickel powder is oxidized in the furnace to produce nickel oxide, nickel is +2-valence, and the +2-valence nickel could be completely dissolved without adding a reducing agent when dissolved in sulfuric acid.

In this step, the nickel powder reacts with air under a certain proportion at a high temperature, and the nickel in the nickel powder is oxidized from 0 valence to +2 valence. Experimental data are shown in Table 1, Table 2 and Table 3.

TABLE 1
Oxidation degrees with different consumptions of
compressed air at 450° C. after reaction for 1 hour

| | | | | | | | |
|---|---|---|---|---|---|---|---|
| Compressed air | 0.5 | 1 | 2 | 3 | 4 | 5 | 6 |
| Nickel | 91.37% | 83.44% | 80.19% | 78.77% | 78.19% | 77.53% | 77.31% |
| content | | | | | | | |
| Oxidation | 34.74% | 72.98% | 90.81% | 99.08% | 100% | 100% | 100% |
| rate | | | | | | | |

TABLE 2
Oxidation degrees with 4 m³ of compressed air at
450° C. after reaction for different periods

| Reaction time | 0.3 h | 0.5 h | 1 h | 1.5 h | 2 h | 2.5 h |
|---|---|---|---|---|---|---|
| Nickel content | 93.45% | 89.26% | 78.19% | 77.93% | 77.91% | 76.81% |
| Oxidation rate | 25.74% | 44.23% | 100% | 100% | 100% | 100% |

TABLE 3
Oxidation degrees with 4 m³ of compressed air at
different reaction temperatures after reaction for 1 hour

| Reaction | | | | | | |
|---|---|---|---|---|---|---|
| temperature | 200° C. | 300° C. | 400° C. | 500° C. | 600° C. | 700° C. |
| Nickel content | 98.48% | 85.89% | 79.11% | 78.24% | 75.09% | 73.29% |
| Oxidation rate | 5.66% | 60.41% | 97.09% | 100% | 100% | 100% |

The oxidation rate is calculated on the basis that a nickel content of the nickel oxide is 78.58%, and when the nickel content is lower than this content, a small amount of nickel is oxidized into trivalent nickel trioxide, and a nickel content of the nickel trioxide is 70.98%.

The cooling comprises: after the nickel powder is oxidized, cooling the oxidized nickel powder to normal temperature under protection of nitrogen or inert gas. The protection of nitrogen or inert gas is intended to prevent the high-temperature nickel powder from coming into contact with oxygen in the air during the cooling process to be oxidized into the nickel trioxide, the nickel in the nickel trioxide is +3-valence, the reducing agent should be added when the +3-valence nickel is subjected to the acid dissolution, and the +3-valence nickel should be reduced into the +2-valence nickel and then is subjected to the acid dissolution to enter the solution.

The acid leaching comprises: placing the cooled nickel oxide in a reactor, controlling a temperature to be 45° C. to 70° C., adding dilute sulfuric acid to control a pH value to be 0.5 to 1.5, and making the reaction last for 1 hour to 3 hours.

Further, the acid leaching comprises: placing the cooled nickel oxide in the reactor, controlling the temperature to be 50° C. to 60° C., adding the dilute sulfuric acid to control the pH value to be 1, and making the reaction last for 2 hours.

The nickel oxide is dissolved in the sulfuric acid to produce a nickel sulfate solution, and a leaching slag still contains a certain amount of nickel, mainly because a certain amount of nickel trioxide is produced in the oxidation process and is not leached, so that the secondary leaching is needed for reduction leaching.

The copper removal comprises: filtering a nickel sulfate solution, then placing the filtered nickel sulfate solution in a reactor, controlling a reaction temperature to be 45° C. to 80° C., adding 0.8 to 2.0 times of nickel powder according to a mass ratio of a copper content, controlling a PH value to be 1.0 to 3.0, and making the reaction last for 0.5 hour to 2.5 hours.

Further, the copper removal comprises: filtering the nickel sulfate solution, then placing the filtered nickel sulfate solution in the reactor, controlling the reaction temperature to be 45° C. to 70° C., preferably 55° C. to 70° C., adding 1.3 to 1.5 times of nickel powder according to the mass ratio of the copper content, controlling the PH value to be 2.0 to 2.5, and making the reaction last for 1 hour to 2 hours. In this step, an activity of metal is utilized, and the nickel is subjected to a replacement reaction with copper ions in the solution to produce sponge copper, so as to remove copper from the nickel sulfate solution. Specific experimental data are shown in Table 4, Table 5, Table 6 and Table 7.

TABLE 4
Table of effects of different addition times of nickel
powder at 50° C. under PH 1.5 after reaction for 1 hour

| Copper-containing stock solution | 0.057 g/L | 0.057 g/L | 0.057 g/L | 0.057 g/L | 0.057 g/L | 0.057 g/L |
|---|---|---|---|---|---|---|
| Addition times of nickel powder | 0.5 | 0.8 | 1.1 | 1.3 | 1.5 | 2.0 |
| Copper-removal solution | 0.032 g/L | 0.012 g/L | 0.009 g/L | 0.005 g/L | 0.001 g/L | 0.0005 g/L |
| Copper removal rate | 43.86% | 78.95% | 84.21% | 91.23% | 98.25% | 99.12% |

TABLE 5
Table of effects of 1.5 addition times of nickel powder
at 50° C. under PH 1.5 after reaction for different periods

| Copper-containing stock solution | 0.033 g/L | 0.033 g/L | 0.033 g/L | 0.033 g/L | 0.033 g/L | 0.033 g/L |
|---|---|---|---|---|---|---|
| Reaction time | 0.2 h | 0.5 h | 1 h | 1.5 h | 2.0 | 2.5 |
| Copper-removal solution | 0.009 g/L | 0.007 g/L | 0.001 g/L | 0.001 g/L | 0.0008 g/L | 0.0007 g/L |
| Copper removal rate | 72.73% | 78.79% | 96.97% | 96.97% | 97.58% | 97.88% |

TABLE 6
Table of effects of 1.5 addition times of nickel powder
at 50° C. under different PH values after reaction for 1 hour

| Copper-containing stock solution | 0.026 g/L | 0.026 g/L | 0.026 g/L | 0.026 g/L | 0.026 g/L | 0.026 g/L |
|---|---|---|---|---|---|---|
| PH value of reaction | 0.5 | 1.0 | 1.5 | 2.0 | 2.5 | 3.0 |
| Copper-removal solution | 0.012 g/L | 0.0095 g/L | 0.001 g/L | 0.005 g/L | 0.0005 g/L | 0.0005 g/L |
| Copper removal rate | 53.85% | 63.49% | 96.15% | 98.08% | 98.08% | 98.08% |

TABLE 7
Table of effects of 1.5 addition times of nickel powder
at different reaction temperatures under PH 1.5 after reaction for 1 hour

| Copper-containing stock solution | 0.071 g/L | 0.071 g/L | 0.071 g/L | 0.071 g/L | 0.071 g/L | 0.071 g/L |
|---|---|---|---|---|---|---|
| Reaction temperature | 35° C. | 45° C. | 55° C. | 65° C. | 70° C. | 80° C. |
| Copper-removal solution | 0.005 g/L | 0.001 g/L | 0.001 g/L | 0.0008 g/L | 0.0005 g/L | 0.0005 g/L |
| Copper removal rate | 92.96% | 98.59% | 98.59% | 98.87% | 99.29% | 99.29% |

The acid adjustment comprises: filtering the nickel sulfate solution subjected to the copper removal, placing the filtered nickel sulfate solution in a reactor, controlling a reaction temperature to be 55° C. to 90° C., and adjusting a PH value to be 2.5 to 4.5 with nickel carbonate or nickel hydroxide.

Further, the acid adjustment comprises: filtering the nickel sulfate solution subjected to the copper removal, placing the filtered nickel sulfate solution in the reactor, controlling the reaction temperature to be 60° C. to 80° C., and adjusting the PH value to be 3.0 to 4.0 with the nickel carbonate or the nickel hydroxide.

Further, the acid adjustment comprises: filtering the nickel sulfate solution subjected to the copper removal, placing the filtered nickel sulfate solution in the reactor, controlling the reaction temperature to be 70° C. to 75° C., and adjusting the PH value to be 3.5 with the nickel carbonate or the nickel hydroxide.

The adjustment of the PH value is mainly intended to reduce free acid in the nickel sulfate crystals, increase a depth of nickel ions, and precipitate impurity iron ions in the acid adjustment process to be separated from the nickel sulfate solution.

The concentration comprises: filtering the nickel sulfate solution subjected to the acid adjustment, and evaporating and concentrating a filtrate. The water evaporation further increased a concentration of nickel ions to promote the smooth crystallization of the nickel sulfate.

The cooling crystallization comprises: making the nickel sulfate solution subjected to the concentration flow into a crystallization device to be cooled, separating nickel sulfate from the solution to form crystals in a temperature reduction process, and after the crystals are separated, returning a mother solution to the concentration.

The drying and screening comprises: drying the separated nickel sulfate crystals by drying equipment to remove free water, and then making the dried crystals enter a vibrating screen for screening. An oversize material is a nickel sulfate product, and undersize material particles are fine and returned to the crystallization to be used as seed crystals.

The secondary leaching comprises: placing the leaching slag in the reactor, wherein the leaching slag is filtered after the acid leaching and contains the certain amount of nickel, adding the dilute sulfuric acid to control the PH value to be 0.5 to 1.5, controlling the reaction temperature to be 45° C. to 70° C., taking the nickel sulfide or the hydrogen peroxide as the reducing agent, with the use amount of 15% to 35% of the nickel content in the acid leaching slag, making the reaction last for 1 hour to 3 hours, taking the slag for nickel detection, when the nickel is less than 0.1%, regarding the slag as a waste slag, when the nickel is greater than 0.1%, continuously returning the slag to the secondary leaching, and returning a leachate to the acid leaching to be used as bottom water or merge with a first leachate to enter the next procedure, so as to ensure a recovery rate of nickel.

Further, the secondary leaching comprises: placing the leaching slag containing the certain amount of nickel in the reactor, adding the dilute sulfuric acid to control the PH value to be 1.0, controlling the reaction temperature to be 50° C. to 65° C., taking the nickel sulfide as the reducing agent, with the use amount of 20% to 30% of the nickel content in the acid leaching slag, and making the reaction last for 2 hours.

Implementation Mode 2: as shown in FIG. 2 to FIG. 5, a crystallization device for preparing electronic-grade nickel sulfate from nickel powder is provided, wherein the crystallization device is composed of three crystallizers with the same structure connected in series, which means that the crystallization device is composed of a first-stage crystallizer 1, a second-stage crystallizer 2 and a third-stage crystallizer 3 which are connected in series, the crystallizer is composed of a crystallization frame 4, an oscillator 6 arranged below the crystallization frame 4 and a liquid discharge port 5 with a control valve arranged at a liquid outlet end of the crystallization frame 4, the crystallization frame 4 is made into a cuboid, raised strips 7 with an arc-shaped cross section are uniformly distributed at a bottom portion of the crystallization frame 4, a distance S between two adjacent raised strips 7 is 1/25 to 1/15 of a width of the crystallization frame 4, and a width b and a height h of the raised strip 7 are both 1/100 to 1/150 of the width of the crystallization frame 4.

Further, the distance S between two adjacent raised strips is 1/20 of the width of the crystallization frame, and the width b and the height h of the raised strip are both 1/110 to 1/130, preferably 1/120, of the width of the crystallization frame.

A main function of the raised strip is that the produced nickel sulfate crystal particles are not easy to harden during rolling between the raised strips under an action of the oscillator during crystallization, and in addition, a contact area is increased, so that a cooling effect is improved.

An influence of a ratio of the distance S between two adjacent raised strips 7 to the width of the crystallization frame 4 on a crystallization oscillation effect is shown in Table 8.

| | | | | | | |
|---|---|---|---|---|---|---|
| Ratio | 1/5 | 1/10 | 1/15 | 1/20 | 1/25 | 1/30 |
| Cooling time | 187 | 173 | 170 | 159 | 146 | 143 |
| | minutes | minutes | minutes | minutes | minutes | minutes |
| Proportion of | 65.17% | 73.24% | 78.16% | 87.11% | 83.22% | 81.28% |
| oversize material | | | | | | |
| Irregular particles | A few | A few | None | None | None | None |

Based on the data of the stock solution in the above table, when a ratio of the width b and the height h of the raised strip 7 to the width of the crystallization frame 4 is the same, data are detected after cooling to 30° C.

An influence of the ratio of the width b and the height h of the raised strip 7 to the width of the crystallization frame 4 on a crystallization oscillation effect is shown in Table 9.

| | | | | | | |
|---|---|---|---|---|---|---|
| Ratio | 1/90 | 1/100 | 1/110 | 1/120 | 1/150 | 1/200 |
| Cooling time | 179 | 167 | 152 | 131 | 139 | 121 |
| | minutes | minutes | minutes | minutes | minutes | minutes |
| Proportion of | 80.11% | 82.35% | 80.69% | 81.37% | 76.48% | 64.31% |
| oversize material | | | | | | |
| Irregular particles | A few | None | None | None | None | None |

Based on the data of the stock solution in the above table, when the ratio of the distance S between the raised strips 7 to the width of the crystallization frame 4 is the same, data are detected after cooling to 30° C.

A control method of a crystallization device for preparing electronic-grade nickel sulfate from nickel powder comprises the following steps of: a: starting a first-stage crystallizer 1: making a concentrated nickel sulfate solution flow into the first-stage crystallizer 1, turning on an oscillator 6, with a frequency of the oscillator not allowing a cobalt sulfate solution to overflow a crystallization frame, after a temperature of the nickel sulfate solution reaches 45° C., making the nickel sulfate solution flow into a second-stage crystallizer 2 through a liquid discharge port 5, and collecting and screening crystals in the crystallization frame 4 to enter the next procedure;
b: starting the second-stage crystallizer 2: after the nickel sulfate solution is placed in the second-stage crystallizer 2, adding undersize material fine particles of the nickel sulfate crystals in the screening procedure for crystallization, other operations being the same as the operations of the first-stage crystallizer, after the temperature of the nickel sulfate solution reaches 35° C., making the nickel sulfate solution flow into a third-stage crystallizer 3 through a liquid discharge port 5, and collecting and screening crystals in a crystallization frame 4 to enter the next procedure; and
c: starting the third-stage crystallizer 3: after the nickel sulfate solution is placed in the third-stage crystallizer 3, adding undersize material fine particles of the nickel sulfate crystals in the screening procedure for crystallization, other operations being the same as the operations of the first-stage crystallizer 1, after the temperature of the nickel sulfate solution reaches room temperature, making the nickel sulfate solution flow into a liquid storage tank through a liquid discharge port 5, and collecting and merging crystals in a crystallization frame 4 to enter the next procedure.

The control method has the advantages that: the crystallization process is carried out under a controllable dynamic condition, and a granularity of crystallization is controllable; the situations of super-large particles, irregular particles and crystal hardening produced under a static condition are avoided; three-stage cooling is adopted in the process, which avoids an influence of an increasing thickness of a crystallization layer during the cooling crystallization on heat dissipation; and the fine undersized nickel sulfate crystals are added into the second and third stage crystallization frames, which act as the seed crystals, thus ensuring the proportion of the oversize material of the nickel sulfate.

Embodiment 1: a method for preparing electronic-grade nickel sulfate from nickel powder comprised the following steps. a. A temperature of 5 kg of nickel powder in a calcining furnace was controlled to be 500° C., 3 m³ of compressed air was injected for each kilogram of nickel powder, and the reaction lasted for 1.5 hours.
b. After the nickel powder was oxidized, the oxidized nickel powder was cooled to normal temperature under protection of nitrogen. The nickel oxide was detected to be 6.5 kg, with a nickel content of 76.85%.
c. The cooled nickel oxide was placed in a reactor, a temperature was controlled to be 50° C., dilute sulfuric acid was added to control a pH value to be to 1.5, and the reaction lasted for 2 hours. After filtration, the solution entered the next procedure, and a leaching slag entered secondary leaching. 42,900 mL of nickel sulfate solution was obtained, with a nickel content of 113.62 g/L and a nickel leaching rate of 97.49%. 180.5 g of leaching slag was obtained, with a nickel content of 69.53%.
d. The above leaching slag was placed in a reactor, dilute sulfuric acid was added to control a PH value to be 0.5, a reaction temperature was controlled to be 62° C., hydrogen peroxide was taken as a reducing agent, with a use amount of 25% of the nickel content in the acid leaching slag, and the reaction lasted for 2 hours. After filtration, 1,190 mL of nickel sulfate solution was obtained, with a nickel content of 105.34 g/L, and 17.5 g of leaching slag was obtained, with a nickel content of 0.083%. A leachate merged with a first leachate to enter the next procedure, and a leaching rate of nickel was 99.99% in combination with two times of leaching.
e. A copper content of the nickel sulfate solution was detected to be 0.009 g/L, in a reactor, a reaction temperature was controlled to be 70° C., 1.5 times of nickel powder was added according to a mass ratio of the copper content, a PH value was controlled to be to 2.3, and the reaction lasted for 1 hour. After filtration, the copper content was detected to be 0.0005 g/L.
f. The nickel sulfate solution subjected to the copper removal was placed in a reactor, a reaction temperature was controlled to be 80° C., a PH value was adjusted to be to 3.5 with nickel hydroxide, and the solution was filtered.
g. The nickel sulfate solution subjected to the acid adjustment was concentrated.
h. The nickel sulfate solution subjected to the concentration flowed into a crystallization device to be cooled to 30° C., wherein room temperature was 23° C., crystals were separated, and then a mother solution was returned to the concentration.
i. The separated nickel sulfate crystals were dried by a circulating drying box to remove free water, and then the dried crystals entered a vibrating screen for screening. An oversize material was a nickel sulfate product, and undersize material particles were fine and returned to the crystallization to be used as seed crystals. Analysis and detection data of the nickel sulfate crystals were obtained as follows: Ni: 22.41%, Co: 0.007%, Fe: 0.0005%, Cu: 0.0001%, Na: 0.001%, Zn: 0.0001%, Ca: 0.0021%, Mg: 0.0017%, Mn: 0.0002%, Cd: 0.0001%, Hg: 0.0001%, Cr: 0.0002%, and Pb: 0.0002%.

Embodiment 2: a method for preparing electronic-grade nickel sulfate from nickel powder comprised the following steps. a. A temperature of 5 kg of nickel powder in a calcining furnace was controlled to be 520° C., 3.5 m³ of compressed air was injected for each kilogram of nickel powder, and the reaction lasted for 1.5 hours.
b. After the nickel powder was oxidized, the oxidized nickel powder was cooled to normal temperature under protection of nitrogen. The nickel oxide was detected to be 6.7 kg, with a nickel content of 74.63%.
c. The cooled nickel oxide was placed in a reactor, a temperature was controlled to be 70° C., dilute sulfuric acid was added to control a pH value to be to 1.5, and the reaction lasted for 2 hours. After filtration, the solution entered the next procedure, and a leaching slag entered secondary leaching. 41,980 mL of nickel sulfate solution was obtained, with a nickel content of 111.38 g/L and a nickel leaching rate of 93.51%. 462.4 g of leaching slag was obtained, with a nickel content of 70.13%.
d. The above leaching slag was placed in a reactor, dilute sulfuric acid was added to control a PH value to be 0.5, a reaction temperature was controlled to be 57° C., hydrogen peroxide was taken as a reducing agent, with a use amount of 18% of the nickel content in the acid leaching slag, and the reaction lasted for 2 hours. After filtration, 2,780 mL of nickel sulfate solution was obtained, with a nickel content of 115.77 g/L, and 23.3 g of leaching slag was obtained, with a nickel content of 11.41%. A leachate merged with a first leachate to enter the next procedure, the leaching slag was continuously subjected to secondary leaching, and a leaching rate of nickel was 99.94% in combination with two times of leaching.
e. A copper content of the nickel sulfate solution was detected to be 0.016 g/L, in a reactor, a reaction temperature was controlled to be 50° C., 1.5 times of nickel powder was added according to a mass ratio of the copper content, a PH value was controlled to be to 2.7, and the reaction lasted for 1 hour. After filtration, the copper content was detected to be 0.0005 g/L.
f. The nickel sulfate solution subjected to the copper removal was placed in a reactor, a reaction temperature was controlled to be 75° C., a PH value was adjusted to be to 3.2 with nickel hydroxide, and the solution was filtered.
g. The nickel sulfate solution subjected to the acid adjustment was concentrated.
h. The nickel sulfate solution subjected to the concentration flowed into a crystallization device to be cooled to 30° C., wherein room temperature was 22° C., crystals were separated, and then a mother solution was returned to the concentration.
i. The separated nickel sulfate crystals were dried by a circulating drying box to remove free water, and then the dried crystals entered a vibrating screen for screening. An oversize material was a nickel sulfate product, and undersize material particles were fine and returned to the crystallization to be used as seed crystals. Analysis and detection data of the nickel sulfate crystals were obtained as follows: Ni: 22.28%, Co: 0.005%, Fe: 0.0005%, Cu: 0.0001%, Na: 0.0031%, Zn: 0.0001%, Ca: 0.0058%, Mg: 0.0047%, Mn: 0.0002%, Cd: 0.0001%, Hg: 0.0001%, Cr: 0.0002%, and Pb: 0.0002%.

Embodiment 3: a method for preparing electronic-grade nickel sulfate from nickel powder comprised the following steps. a. A temperature of 5 kg of nickel powder in a calcining furnace was controlled to be 450° C., 2.5 m³ of compressed air was injected for each kilogram of nickel powder, and the reaction lasted for 1.5 hours.
b. After the nickel powder was oxidized, the oxidized nickel powder was cooled to normal temperature under protection of nitrogen. The nickel oxide was detected to be 6.43 kg, with a nickel content of 77.76%.
c. The cooled nickel oxide was placed in a reactor, a temperature was controlled to be 65° C., dilute sulfuric acid was added to control a pH value to be to 1.5, and the reaction lasted for 2 hours. After filtration, the solution entered the next procedure, and a leaching slag entered secondary leaching. 40,450 mL of nickel sulfate solution was obtained, with a nickel content of 123.54 g/L and a nickel leaching rate of 99.94%. 4.2 g of leaching slag was obtained, with a nickel content of 66.79%. Due to the small amount of slag, the leaching slag directly entered the leaching procedure without being subjected to secondary leaching.
d. A copper content of the nickel sulfate solution was detected to be 0.041 g/L, in a reactor, a reaction temperature was controlled to be 50° C., 1.5 times of nickel powder was added according to a mass ratio of the copper content, a PH value was controlled to be to 2.0, and the reaction lasted for 1 hour. After filtration, the copper content was detected to be 0.0003 g/L.
e. The nickel sulfate solution subjected to the copper removal was placed in a reactor, a reaction temperature was controlled to be 65° C., a PH value was adjusted to be to 3.8 with nickel hydroxide, and the solution was filtered.
f. The nickel sulfate solution subjected to the acid adjustment was concentrated.
g. The nickel sulfate solution subjected to the concentration flowed into a crystallization device to be cooled to 30° C., wherein room temperature was 22° C., crystals were separated, and then a mother solution was returned to the concentration.
h. The separated nickel sulfate crystals were dried by a circulating drying box to remove free water, and then the dried crystals entered a vibrating screen for screening. An oversize material was a nickel sulfate product, and undersize material particles were fine and returned to the crystallization to be used as seed crystals. Analysis and detection data of the nickel sulfate crystals were obtained as follows: Ni: 22.30%, Co: 0.001%, Fe: 0.0003%, Cu: 0.0001%, Na: 0.0011%, Zn: 0.0001%, Ca: 0.0052%, Mg: 0.0052%, Mn: 0.0002%, Cd: 0.0001%, Hg: 0.0001%, Cr: 0.0002%, and Pb: 0.0002%.

Embodiment 4: a crystallization device for preparing electronic-grade nickel sulfate from nickel powder is provided, as shown in FIG. 2 to FIG. 5, the crystallization device is composed of three crystallizers with the same structure connected in series, which means that the crystallization device is composed of a first-stage crystallizer 1, a second-stage crystallizer 2 and a third-stage crystallizer 3 which are connected in series, the crystallizer is composed of a crystallization frame 4, an oscillator 6 arranged below the crystallization frame 4 and a liquid discharge port 5 with a control valve arranged at a liquid outlet end of the crystallization frame 4, the oscillator 6 adopts a SC420 horizontal reciprocating oscillator of Shanghai Dam Industry Co., Ltd., the crystallization frame 4 is made into a cuboid, convex strips 7 with an arc-shaped cross section are uniformly distributed at a bottom portion of the crystallization frame 4, a distance S between two adjacent convex strips 7 is 1/20 of a width of the crystallization frame 4, and a width b and a height h of the convex strip 7 are both 1/100 of the width of the crystallization frame 4.

This embodiment has the technical effects that: the crystallization process of the nickel sulfate is a dynamic process and carried out under a controllable dynamic condition, a granularity of crystallization is controllable, the situations of super-large particles, irregular particles and crystal hardening produced under a static condition are avoided, and meanwhile, an influence of an increasing thickness of a crystallization layer during the cooling crystallization on heat dissipation is avoided.

Embodiment 5: a control method of a crystallization device for preparing electronic-grade nickel sulfate from nickel powder comprised the following steps.
a: A first-stage crystallizer 1 was started: a concentrated nickel sulfate solution flowed into the first-stage crystallizer 1, an oscillator 6 was turned on, with a frequency of the oscillator 6 not allowing a cobalt sulfate solution to overflow a crystallization frame 4, after a temperature of the nickel sulfate solution reached 45° C., the nickel sulfate solution flowed into a second-stage crystallizer 2 through a liquid discharge port 5 with a control valve, and crystals were collected and then merged in the crystallization frame 4 to enter the next procedure.
b: The second-stage crystallizer 2 was started: after the nickel sulfate solution was placed in the second-stage crystallizer 2, undersize material fine particles of the nickel sulfate crystals in the screening procedure were added for crystallization, other operations were the same as the operations of the first-stage crystallizer 1, after the temperature of the nickel sulfate solution reached 35° C., the nickel sulfate solution flowed into a third-stage crystallizer 3 through a liquid discharge port 5 with a control valve of the second-stage crystallizer 2, and crystals in a crystallization frame 4 of the second-stage crystallizer 2 were collected and then merged to enter the next procedure.
c: The third-stage crystallizer 3 was started: after the nickel sulfate solution was placed in the third-stage crystallizer 3, undersize material fine particles of the nickel sulfate crystals in the screening procedure were added for crystallization, other operations were the same as the operations of the first-stage crystallizer 1, after the temperature of the nickel sulfate solution reached room temperature, the nickel sulfate solution flowed into a liquid storage tank through a liquid discharge port 5 with a control valve of the third-stage crystallizer 3, and crystals in a crystallization frame 4 of the third-stage crystallizer 3 were collected and then merged to enter the next procedure. This embodiment has the technical effects that: the crystallization process is carried out under a controllable dynamic condition, and a granularity of crystallization is controllable; the situations of super-large particles, irregular particles and crystal hardening produced under a static condition are avoided; three-stage cooling is adopted in the process, which avoids an influence of an increasing thickness of a crystallization layer during the cooling crystallization on heat dissipation; and the fine undersized nickel sulfate crystals are added into the second and third stage crystallization frames, which act as the seed crystals, thus ensuring the proportion of the oversize material of the nickel sulfate.

The above are only the preferred embodiments of the present invention and are not intended to limit the present invention. For those skilled in the art, the present invention may have various modifications and changes. Any modification, equivalent substitution, improvement, etc. made within the spirit and principle of the present invention are included in the scope of protection of the present invention.

### INDUSTRIAL APPLICABILITY

The present invention has been put into industrial production and application, the prepared nickel sulfate all reaches the standard of the electronic-grade nickel sulfate.

We claim:

1. A method for preparing and producing electronic-grade nickel sulfate from nickel powder, comprising the following steps of: oxidation, cooling, acid leaching, copper removal, acid adjustment, concentration, cooling crystallization, drying and screening, and secondary leaching, wherein:
the oxidation comprises: controlling a temperature of nickel powder in a calcining furnace to be 400° C. to 700° C., injecting 1 m³ to 5 m³ of compressed air for each kilogram of nickel powder, and making the reaction last for 1.0 hour to 2.0 hours, so that the nickel powder is oxidized in the furnace, and +2-valence nickel oxide is produced;
the cooling comprises: after the nickel powder is oxidized, cooling the oxidized nickel powder to normal temperature under protection of nitrogen or inert gas;
the acid leaching comprises: placing the cooled nickel oxide in a reactor, controlling a temperature to be 45° C. to 70° C., adding dilute sulfuric acid to control a pH value to be 0.5 to 1.5, and making the reaction last for 1 hour to 3 hours;
the copper removal comprises: filtering a nickel sulfate solution, then placing the filtered nickel sulfate solution in a reactor, controlling a reaction temperature to be 45° C. to 80° C., adding 0.8 to 2.0 times of nickel powder according to a mass ratio of a copper content, controlling a PH value to be 1.0 to 3.0, and making the reaction last for 0.5 hour to 2.5 hours;
the acid adjustment comprises: filtering the nickel sulfate solution subjected to the copper removal, placing the filtered nickel sulfate solution in a reactor, controlling a reaction temperature to be 55° C. to 90° C., and adjusting a PH value to be 2.5 to 4.5 with nickel carbonate or nickel hydroxide;
the concentration comprises: filtering the nickel sulfate solution subjected to the acid adjustment, and concentrating a filtrate;
the cooling crystallization comprises: making the nickel sulfate solution subjected to the concentration flow into a crystallization device to be cooled, separating nickel sulfate from the solution to form crystals in a temperature reduction process, and after the crystals are separated, returning a mother solution to the concentration;
the drying and screening comprise: drying the separated nickel sulfate crystals by a vibrated fluidized bed to remove free water, and then making the dried crystals enter a vibrating screen for screening, wherein an oversize material is a nickel sulfate product, and undersize material particles are fine and returned to the crystallization to be used as seed crystals; and
the secondary leaching comprises: placing a leaching slag containing a certain amount of nickel in a reactor, adding dilute sulfuric acid to control a PH value to be 0.5 to 1.5, controlling a reaction temperature to be 45° C. to 70° C., taking nickel sulfide or hydrogen peroxide as a reducing agent, with a use amount of 15% to 35% of a nickel content in the acid leaching slag, making the reaction last for 1 hour to 3 hours, taking the slag for nickel detection, when the nickel is less than 0.1%, regarding the slag as a waste slag, when the nickel is greater than 0.1%, continuously returning the slag to the secondary leaching, and returning a leachate to the acid leaching to be used as bottom water or merge with a first leachate to enter the next procedure, so as to ensure a recovery rate of nickel.

2. The method for preparing the electronic-grade nickel sulfate from the nickel powder according to claim 1, wherein the oxidation comprises: controlling the temperature of nickel powder in the calcining furnace to be 450° C. to 600° C., preferably 500° C., injecting 3 m³ to 4 m³ of compressed air for each kilogram of nickel powder, and making the reaction last for 1.0 hour to 1.5 hours.

3. The method for preparing the electronic-grade nickel sulfate from the nickel powder according to claim 1, wherein the acid leaching comprises: placing the cooled nickel oxide in the reactor, controlling the temperature to be 50° C. to 60° C., adding the dilute sulfuric acid to control the pH value to be 1, and making the reaction last for 2 hours.

4. The method for preparing the electronic-grade nickel sulfate from the nickel powder according to claim 1, wherein the copper removal comprises: filtering the nickel sulfate solution, then placing the filtered nickel sulfate solution in the reactor, controlling the reaction temperature to be 45° C. to 70° C., preferably 55° C. to 70° C., adding 1.3 to 1.5 times of nickel powder according to the mass ratio of the copper content, controlling the PH value to be 2.0 to 2.5, and making the reaction last for 1 hour to 2 hours.

5. The method for preparing the electronic-grade nickel sulfate from the nickel powder according to claim 1, wherein the acid adjustment comprises: filtering the nickel sulfate solution subjected to the copper removal, placing the filtered nickel sulfate solution in the reactor, controlling the reaction temperature to be 60° C. to 80° C., and adjusting the PH value to be 3.0 to 4.0 with the nickel carbonate or the nickel hydroxide.

6. The method for preparing the electronic-grade nickel sulfate from the nickel powder according to claim 5, wherein the acid adjustment comprises: filtering the nickel sulfate solution subjected to the copper removal, placing the filtered nickel sulfate solution in the reactor, controlling the reaction temperature to be 70° C. to 75° C., and adjusting the PH value to be 3.5 with the nickel carbonate or the nickel hydroxide.

7. The method for preparing the electronic-grade nickel sulfate from the nickel powder according to claim 1, wherein the secondary leaching comprises: placing the leaching slag containing the certain amount of nickel in the reactor, adding the dilute sulfuric acid to control the PH value to be 1.0, controlling the reaction temperature to be 50° C. to 65° C., taking the nickel sulfide as the reducing agent, with the use amount of 20% to 30% of the nickel content in the acid leaching slag, and making the reaction last for 2 hours.

8. A crystallization device for preparing electronic-grade nickel sulfate from nickel powder, wherein the crystallization device is composed of a first-stage crystallizer, a second-stage crystallizer and a third-stage crystallizer which are connected in series, the crystallizer is composed of a crystallization frame, an oscillator arranged below the crystallization frame and a liquid discharge port with a control valve arranged at a liquid outlet end of the crystallization frame, the crystallization frame is made into a cuboid, raised strips with an arc-shaped cross section are uniformly distributed at a bottom portion of the crystallization frame, a distance S between two adjacent raised strips is 1/25 to 1/15 of a width of the crystallization frame, and a width b and a height h of the raised strip are both 1/100 to 1/150 of the width of the crystallization frame.

9. The crystallization device for preparing the electronic-grade nickel sulfate from the nickel powder according to claim 8, wherein the distance S between two adjacent raised strips is 1/20 of the width of the crystallization frame, and the width b and the height h of the raised strip are both 1/110 to 1/140 of the width of the crystallization frame.

10. An electronic-grade nickel sulfate product prepared by the method and crystallization device for preparing the electronic-grade nickel sulfate from the nickel powder, and the control method of the crystallization device according to claim 1.
